(19) United States
(12) Patent Application Publication
(10) Pub. No.: US 2002/0174039 A1
(43) Pub. Date: Nov. 21, 2002

(54) Virtual hub

(75) Inventor: Chih-Hung Chien, Tao-Yuan Hsien (TW)

Correspondence Address: MERCHANT & GOULD PC, P.O. BOX 2903, MINNEAPOLIS, MN, 55402-0903, US

(73) Assignee: Mitac International Corp., Hsinchu (TW)

(21) Appl. No.: 10/123,673

(22) Filed: Apr. 16, 2002

(30) Foreign Application Priority Data
May 18, 2001 (TW) 090111904

(51) Int. Cl. G06F 17/60; H04L 12/56; H04L 12/28

(52) U.S. Cl. 705/28; 370/389

(57) ABSTRACT

An automatic virtual hub used in the purchase procedure, inventory management and manufacturing procedure of the supply chain in the manufacturing industry is disclosed. The virtual hub can effectively reduce both stocks and manpower processing costs on both parties in the supply chain by 50%. The ERP system of either party in supply chain can control this virtual hub for MRP. Through a web, various messages are transmitted to any EOI on the web by EDI.

### BACKGROUND OF THE INVENTION

1. Field of Invention

The invention relates to a virtual hub and, in particular, to an automatic virtual hub used in the purchase procedure, inventory management, and manufacturing procedure of the supply chain in the manufacturing industry.

2. Related Art

The inventory management in ordinary manufacturers is inherited from conventional management methods for stock control, order processing and materials distributions. In wake of the E-business era, it has to be appropriately planned in order to satisfy the real-time demands of the inventory management model of the manufacturer.

However, the inventory management in conventional manufacturers has the following drawbacks:

1. The order processing procedure from receiving orders to shipping is usually done by fax, thus often resulting in missing shipping notes and orders.

2. When orders requiring immediate attentions are given to vendors or retailers, order confirmations have to be returned before a deadline. However, there is no way for the stocks and shipping of components to learn about whether orders have been confirmed or not.

3. It is impossible to know stocks, order and shipping notices.

4. One cannot know the information of the location of trucks or component stocks in the warehouses of all branch offices.

5. Customers cannot communicate and exchange files with retailers all over the world to obtain local market sales and data.

Therefore, under the globalization needs, inventory management in conventional manufacturers has to solve the above problems. An inventory management system should be developed together, covering local hubs of the headquarter, branch offices, and retailers. At the same time, one has to develop an order management system on the inventory management system, so as to increase the efficiency in order confirmations and the quality of shipping notices and deliveries. In other words, under the E-business system structure, the conditions of overseas branch offices and retailers are transmitted among one another through a network, making information exchanges and control much easier.

### SUMMARY OF THE INVENTION

The disclosed virtual hub can integrate vendors and design a total solution for them. It further expands the corporations with down-stream vendors for providing solutions to customer stocks, orders, and shipping. In regards to electronic services, the virtual hub is connected with up- and down-stream EDI's. Using the management system and customer inquiry system of the virtual hub, a total supply management mechanism for precision materials preparation and online purchases along with BTO is provided to customers.

An primary objective of the invention aims at automation of the whole purchase procedure, inventory management and manufacturing procedure in such a way that both parties in the supply chain can effective reduce their stocks and manpower processing costs by 50%. This includes the steps of:

combining information of stocks at both parties and treating it as a virtual hub in management;

enabling the enterprise resource planning (ERP) systems of both parties to access and control this virtual hub for manufacturing resource planning (MRP);

processing materials receptions and deliveries of the virtual hub through a web;

the vendor automatically generating invoices, standard packing lists, advance shipping notices (ASN), and account receivables (AR) after materials are shipped out from the virtual hub and the customer automatically generating messages of materials receptions and account payables; and

controlling internal stocks.

The virtual hub automatically transmits various kinds of message to systems at both parties through the EDI on Internet (EOI) on a web. The system operations include:

a central system, i.e. a virtual hub operation system, including the following subsystems: a satellite account management system, a document handling system, a data format mapping system, a message mail system, a security management system, and a satellite account virtual inventory management system.

### BRIEF DESCRIPTION OF THE DRAWINGS

The invention will become more fully understood from the detailed description given hereinbelow illustration only, and thus are not limitative of the present invention, and wherein:

FIG. 1 shows the structure of an operation system in the disclosed virtual hub;

FIG. 2 is a schematic function diagram of the disclosed virtual hub;

FIG. 3 shows a web structure of the disclosed virtual hub;

FIG. 4 shows a connection structure for the virtual hub operation system and a plurality of vendors;

FIG. 5 compares the coding principle of the disclosed HubWeb document management and that of the prior art;

FIG. 6 is an operation flowchart of a conventional document;

FIG. 7 is a flowchart of EDI transmissions;

FIG. 8 shows a standard operation structure of the disclosed data format mapping system; and

FIG. 9 shows an enterprise security structure of the disclosed virtual hub.

### DETAILED DESCRIPTION OF THE INVENTION

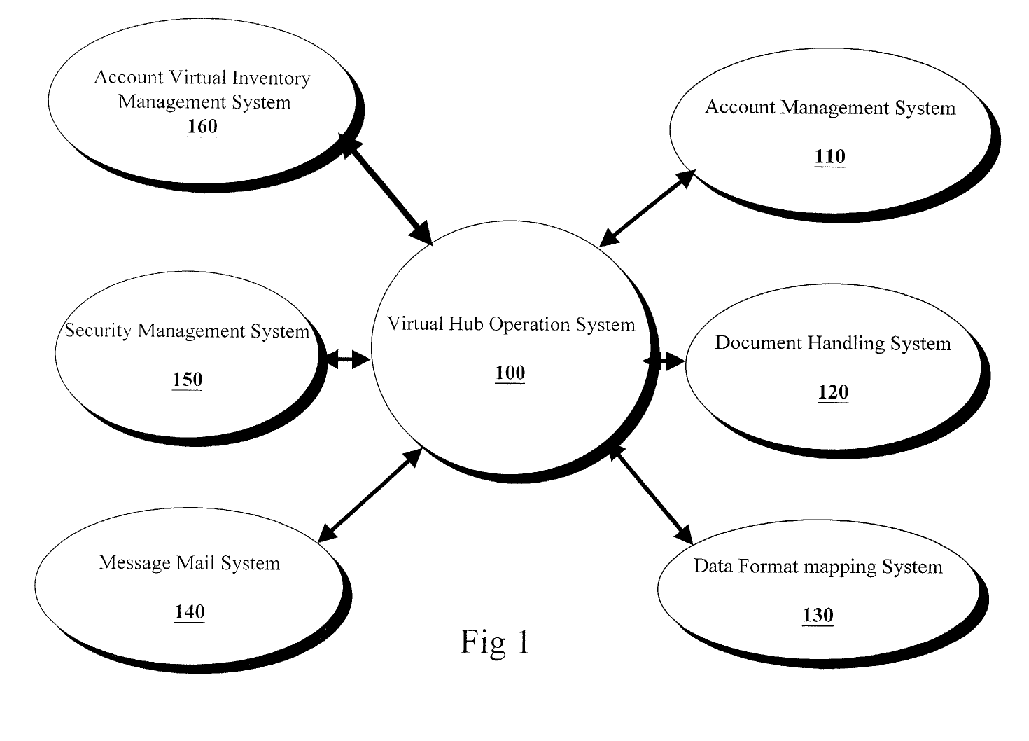

As shown in FIG. 1, the disclosed virtual hub includes a central system, i.e. a virtual hub operation system 100. It contains the following subsystems: a satellite account management system 110, a document handling system 120, a data format mapping system 130, a message mail system 140, a security management system 150, and a satellite account virtual inventory management system 160.

The disclosed virtual hub allows users to login through multi-sites, simultaneously manages several warehouses and multi-storage rooms of each warehouse and executes the above-mentioned functions provided by the subsystems. Each subsystem is detailed in the following paragraphs.

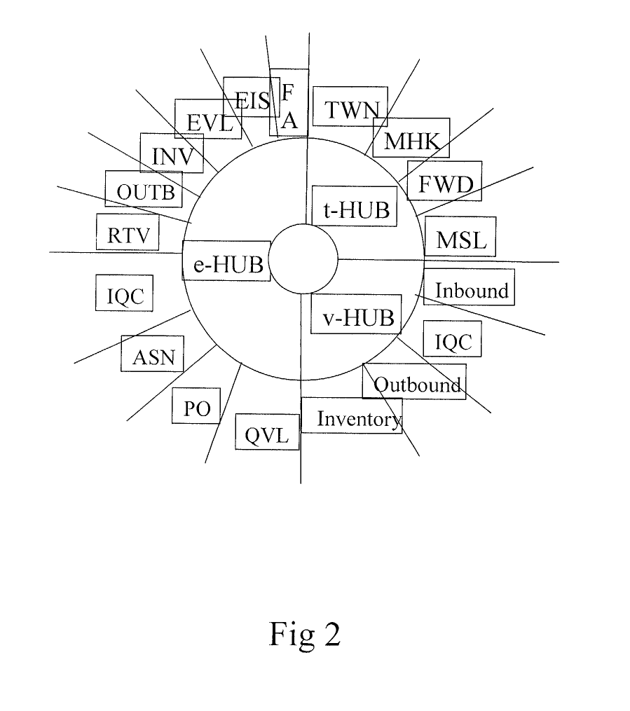

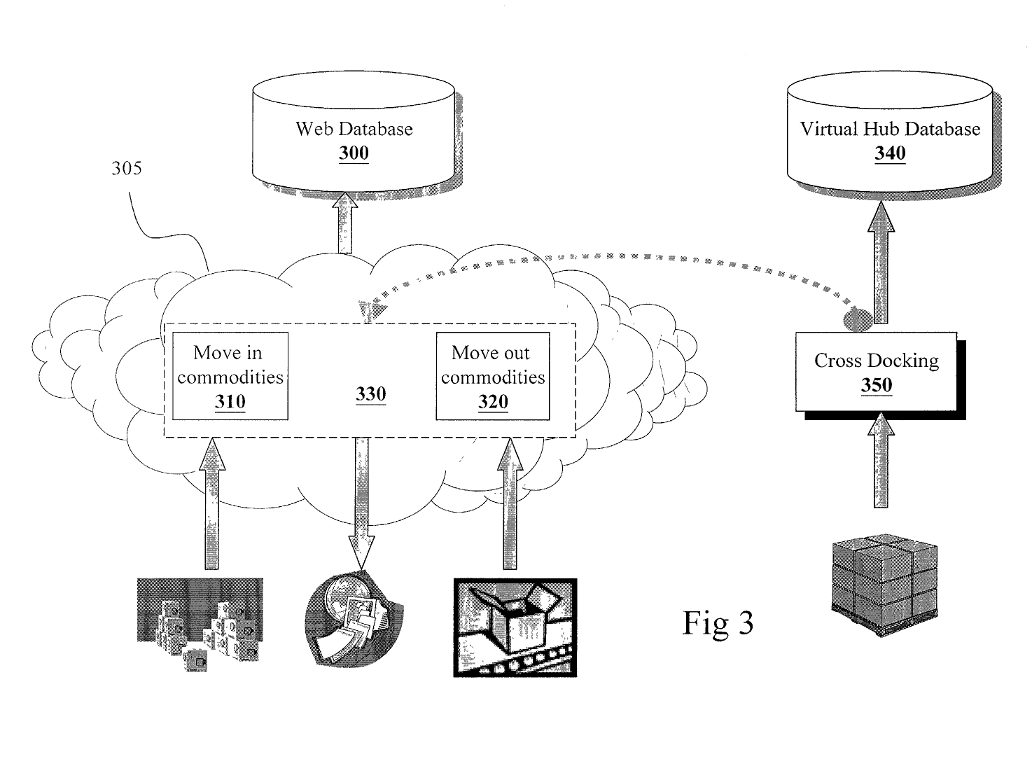

(1) The virtual hub operation system 100: FIG. 2 is a schematic function diagram of the disclosed virtual hub (the provided function types are not described individually here). As shown in FIG. 3, a web database 300 provides a data establishment 330 block for registering commodity move-in 310 and commodity move-out 320. An application service provider (ASP) 305 manages the web database 300. The data in the virtual hub database 340 have to include cross docking data 350. Although they are not stored in actual warehouses, in-and-out data of actual transactions have to be stored in the virtual hub.

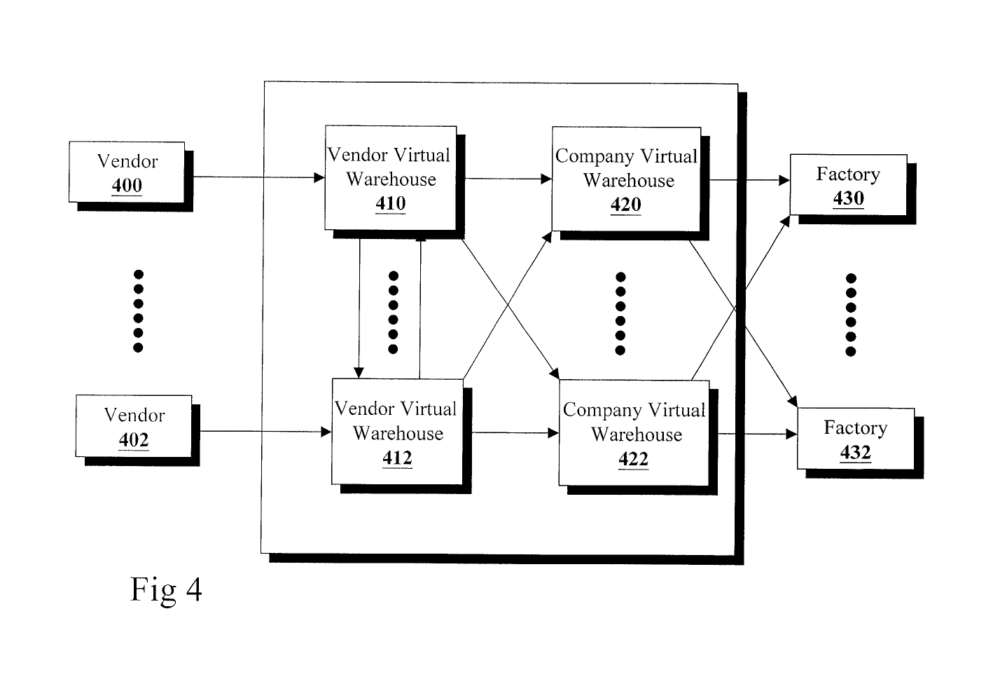

With reference to FIG. 4, the virtual hub operation system 100 has to consider the virtual warehouses 410, 412 of multiple vendors 400, 402 and the connections to the company virtual warehouses 420, 422. That is, the virtual hub operation system 100 has to contain all relevant inventory data for controlling the MRP and materials demands of factory production materials management so that the factories can easily perform product assemblies.

(2) The satellite account management system 110: To become a virtual materials distributing center, the system has to be able to manage materials among multiple customers and vendors. This requires the customer codes/factory codes/warehouse codes/product warehouse (PW) codes/production line codes of customers and the vendor codes/factory codes/warehouse codes/PW codes/production line codes of vendors.

The satellite account management system 110 uses a web, the HubWeb, for vendors to apply for new accounts. A major window control mechanism is established for all vendors that want to use the HubWeb. Besides ensuring the privacy of all relevant data of the vendors, it further supervises the web use privileges of the vendors.

(3) The document handling system 120: Since the whole system is controlled through bar codes on line, all relevant documents such as shipping orders, kit orders, picking lists, delivery orders, counting orders, and bin cards become paperless and are all processed by the system.

The disclosed HubWeb system establishes management guidelines for conventional and electronic documents so that all document copies, distributions, recycles and lendings can be processed under this standard. Therefore, vendors and each unit inside the company can obtain data of the latest version, preventing old or unauthorized document from being used. Data quality and transmission operations can thus become more effective.

Conventional and electronic documents that may affect product delivery dates, shop floor manufacturing, product quality and financial statement checks directly or indirectly due to transmissions or postal deliveries from vendors are within the scope of the document management. In addition, normal standards and drawings, specifications, and examination standards provided by the vendors are also limited by the document management guidelines.

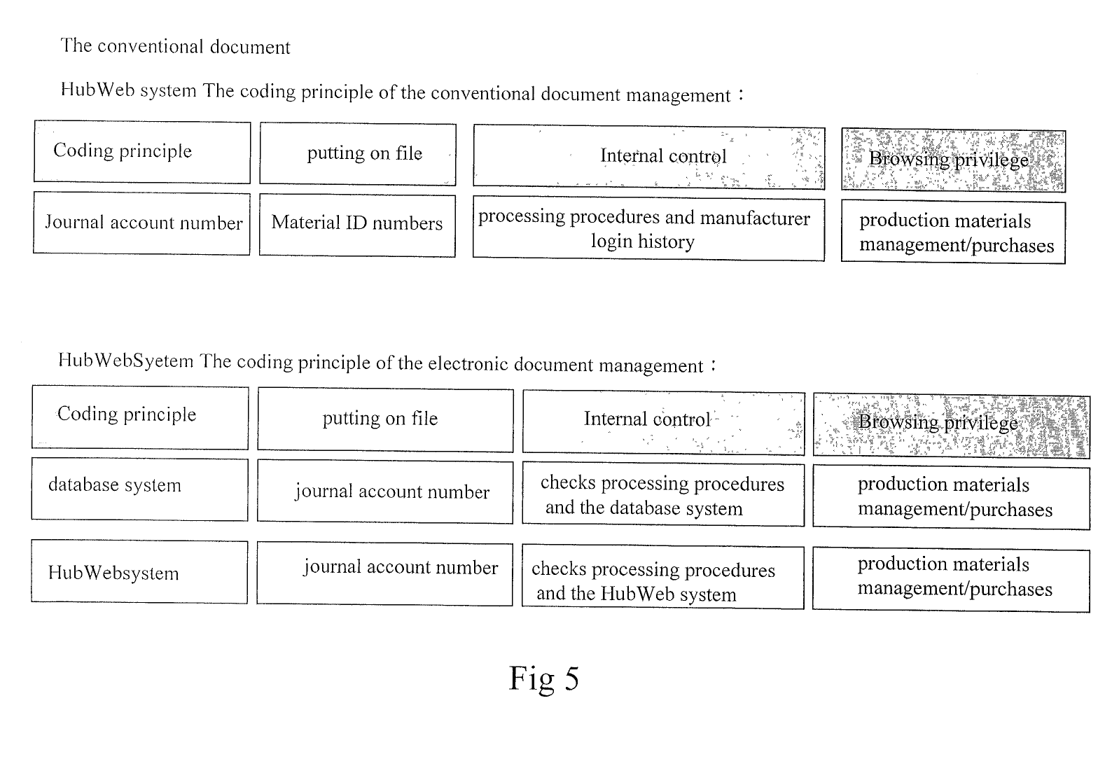

The coding principle of the HubWeb document management and the coding principle of the conventional document management are shown in FIG. 5. The coding principle of the conventional document management uses “date+journal account number” and documents are files according to the material ID numbers. The internal control is performed by checking processing procedures and manufacturer login history. The browsing privilege is limited to production materials management/purchases. The coding principle of the HubWeb document management has two parts: one is generated by a database system, uses the journal account number for filing, checks processing procedures and the database system for internal control, and the browsing privilege is limited to production materials management/purchases; the other is generated by the HubWeb system, uses the journal account number for filing, checks processing procedures and the HubWeb system for internal control, and the browsing privilege is limited to production materials management/purchases.

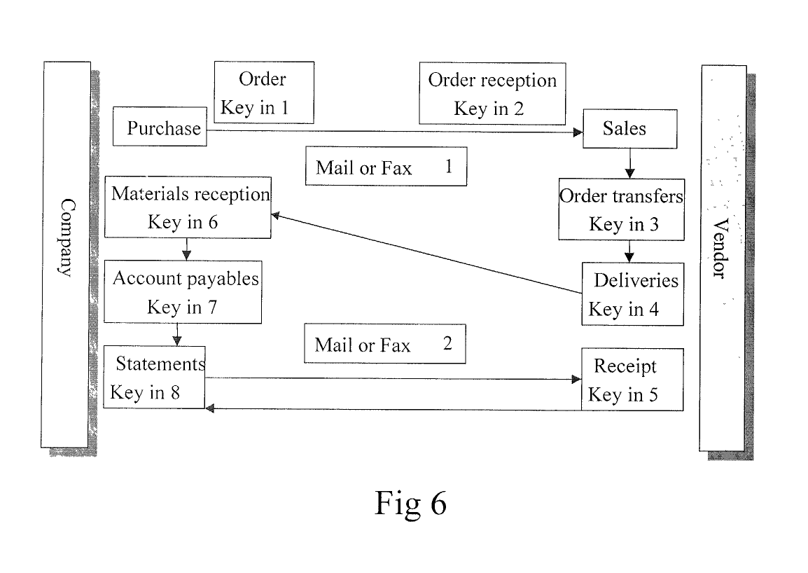

Since the conventional document processing procedure is manually keyed in, the error and repetition probability is too high (see FIG. 6). In normal processing procedures, purchase orders through the company are manually keyed in to the vendor. The vendor also manually keys in to perform order reception, sales, order transfers, deliveries, and receipts. The company also manually keys in to perform materials reception, account payables, statements. Therefore, errors and repetitions occur as long as human factors are involved.

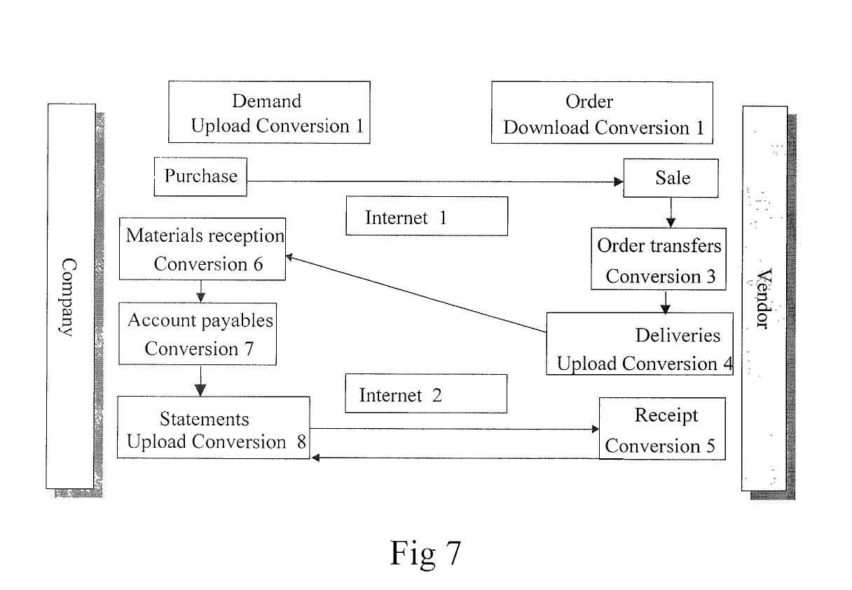

The HubWeb document management uses the EDI transmission procedure to solve drawbacks in human processing (as shown in FIG. 7). Through the common interface of the HubWeb, the purchases of the company and the vendors use the EDI transmission to upload and download conversions. The vendor uploads delivery notices to the HubWeb through an internal conversion mechanism. A receipt is also generated and transmitted to the company. The company performs download conversions for materials reception and internal account payable conversions through the HubWeb. Statements are then generated and uploaded to the HubWeb to check with the receipts produced by the vendors. If there is no mistake, then the vendor downloads to ask for payments.

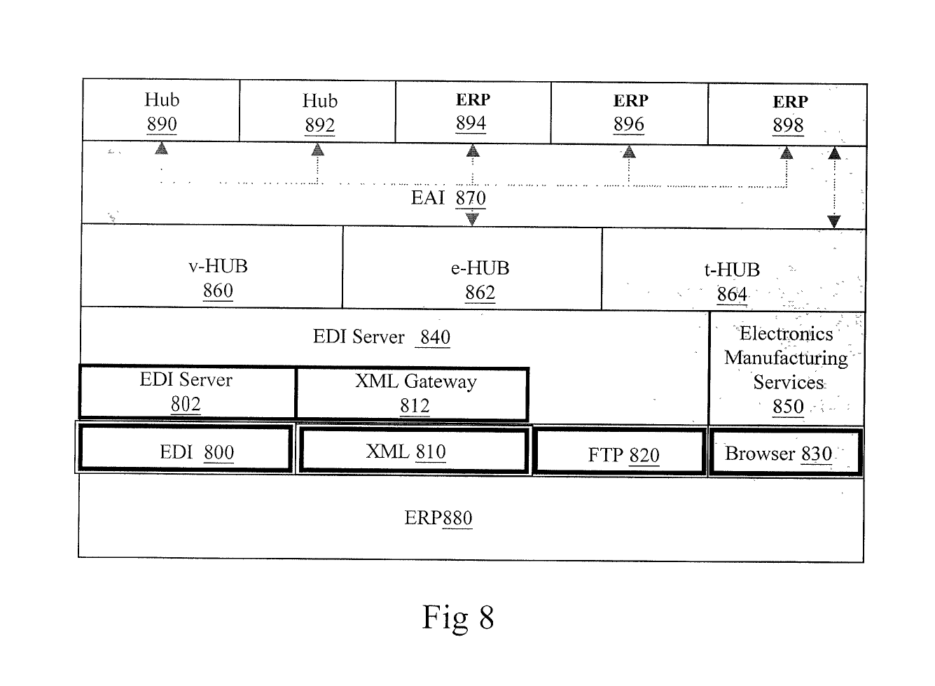

(4) The data format mapping system 130: FIG. 8 shows a standard operation structure of the disclosed data format mapping system. Through the design of a standardized operating system compatible with systems of different characters, transmission protocols such as EDI 800, expandable markup language (XML) 810, file transfer protocol (FTP) 820 or browsers 830 allow customers to use a web page interface, such as an active server page (ASP) or application system interface to inquire inventory, to download warehouse data and material distribution related notices, and to print out inquiries. If the vendor provides multi-warehouse management services, customers can complete the virtual inventory function according to the published information.

Through the data conversion by a data exchange server 840 or an electronic manufacturing service 850, data in a virtual hub (v-HUB) 860, an electronic information exchange hub (e-HUB) 862, and a material tracking hub (t-HUB) 864 are used along with an enterprise application integrated (EAI) interface 870 to combine the enterprise resource planning (ERP) 880 into the hub 890, 892 or the ERP 894, 896, 898 among sources of different characters. The whole procedure in the disclosed active data warehouse is achieved through the above-mentioned standardized operating structure for data exchanges.

For the transmission protocol of the data exchange server 840, the EDI 800 and the XML 810 perform conversions through an EDI server 802 and an XML gateway 812.

In the whole data format conversion system, the data provided or received by the ERP system of each vendor may be different. The invention further provides a data exchange mechanism using the XML, aiming at a data transmission mechanism using the standards set by Rosettanet.

(5) The message mail system 140: Using an automatic mail sending mechanism, both parties are notified of things such as returns, dead materials, rejections that need to be taken care of. Via the connection of a network, work orders and verification can be immediately delivered, ensuring that each message transmission in collaboration commerce is real-time and valid. Taking the invention as an example, a web is designed to provide such mechanisms as order/order confirmation replies, OQA/IQC replies, return notices/classification/checking inquiries, dead materials replies, and receiving bulletin information.

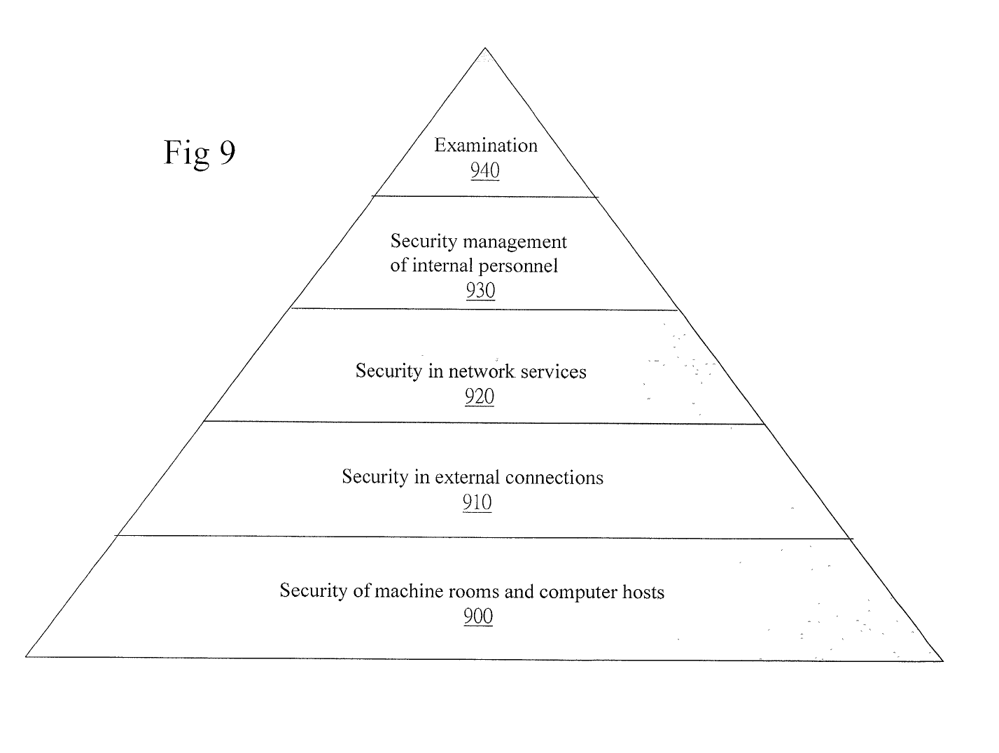

(6) The security management system 150: As shown in FIG. 9, the virtual hub security structure includes five security levels: security of machines and computer hosts 900, security of external connections 910, security of network services 920, management of internal personnel security 930, and inspection 940. The security of machines and computer hosts 900 avoids attacks from Nature. The security of external connections 910 protects privacy and the wholeness of the enterprise network. The security of network services 920 prevents attacks from external hackers or computer viruses. The management of internal personnel security 930 sets certain access privileges to employees, managers, and computer administrators. The inspection 940 provides employee education and security policies.

(7) The satellite account virtual inventory management system 160: According to the techniques, a warehouse can be categorized into one of the following three generations of systems:

Early years: Fixed warehouse personnel manage fixed materials in fixed areas.

Drawbacks:

1. The system has to be manually updated for operation and maintenance conditions. Mistakes and time delays are likely to result.

2. Nobody knows where certain materials are stored if the assigned responsible person is on vacation.

3. Material picking requires that an employee is able to determine whether the picked materials are correct.

4. Material counting requires that an employee is able to determine whether the quantities of materials are correct.

5. One cannot know the stock conditions until all orders are manually input to the system at the end of the day.

6. It is impossible to control FIFO (First-In-First-Out).

7. It is impossible to figure out which material supplier a particular material comes from.

8. Material checking cannot be performed until the operation is stopped.

9. There is no reservation function.

Nowadays: Each locator is controlled. Materials can be randomly stored numbered locators for the system to generate a picking list.

Drawbacks: although some problems in the previous systems are solved, there are still the following problems:

1. Material picking still requires that an employee is able to determine whether the picked materials are correct.

2. Material counting still requires that an employee is able to determine whether the quantities of materials are correct.

3. One cannot know the stocking conditions until all orders are manually input to the system at the end of the day.

4. Material checking cannot be performed until the operation is stopped.

5. There is time delay in its reservation function.

To solve the above problems, using bar code on-line operation along with an RF (Radio Frequency) device or a bar code machine, inventory data seen on a website is exactly the same as the actual inventory data, without any time delay. Through the control of bar codes, the invention can control the stocking conditions of each vendor owner.

Moreover, the disclosed virtual hub is determined according to the ERP of the vendor, allowing each vendor to selectively use batch, real-time, or interactive data transmissions to communicate with the virtual hub. If the data transmission has to achieve real-time effects, the company and vendor have to simultaneously have an application-to-application (A2A) interface for real-time transmissions and receptions.

What is claimed is:

1. A virtual hub using an enterprise application integrated (EAI) interface to combine a plurality of customers, a plurality of manufacturers, a plurality of vendors and a company to transmit messages to among one another, the virtual hub comprising:
a virtual hub operation system, which through the establishment of the web provides connections among the plurality of customers, the plurality of manufacturers, and the plurality of vendors;
a satellite account management system linking to the virtual hub operation system, which establishes a major window control mechanism and performs multiple-to-multiple management of data of the customers and the vendors;
a document handling system linking to the virtual hub operation system, which performs upload conversions and download conversions of exchanged messages;
a data format mapping system linking to the virtual hub operation system, which provides data format conversions for the web;
a message mail system linking to the virtual hub operation system, which uses an automatic mailing mechanism to transmit and receive the message mail;
a security management system linking to the virtual hub operation system, which provides a plurality of security levels; and
a satellite account virtual inventory management system linking to the virtual hub operation system, which performs inventory management so that the inventory data on the web represent the actual inventory data.

2. The virtual hub of claim 1, wherein the virtual hub operation system is operated through an application service provider (ASP).

3. The virtual hub of claim 1, wherein the virtual hub operation system further contains a web database and a virtual hub database.

4. The virtual hub of claim 3, wherein the web database provides data blocks for registering commodity move-in and move-out information.

5. The virtual hub of claim 3 comprising the step of establishing actual transaction data in the virtual hub when the virtual hub database receives a cross docking.

6. The virtual hub of claim 5, wherein the cross docking refers to commodities without actually being in the warehouse.

7. The virtual hub of claim 1, wherein the major window allows the vendor to apply for a new account through a HubWeb.

8. The virtual hub of claim 1, wherein the vendor data include a vendor code, a factory code, a warehouse code, a PW code and a production line code.

9. The virtual hub of claim 1, wherein the document handling system further includes drawings, specifications, and examination standards provided by the vendors.

10. The virtual hub of claim 1, wherein the document handling system further includes drawings, specifications, and examination standards provided by the vendors.

11. The virtual hub of claim 1, wherein the EDI is converted by an EDI server.

12. The virtual hub of claim 1, wherein the XML is converted by an XML gateway.

13. The virtual hub of claim 1, wherein the data format mapping system achieves the function of data transmission to any EOI using the Rosettanet standards.

14. The virtual hub of claim 1, wherein the security of machines and computer hosts avoids attacks from Nature.

15. The virtual hub of claim 1, wherein security of external connections protects privacy and the wholeness of the enterprise network.

16. The virtual hub of claim 1, wherein the security of network services prevents attacks from external hackers and computer viruses.

17. The virtual hub of claim 1, wherein the management of internal personnel security sets certain access privileges to employees, managers, and computer administrators.

18. The virtual hub of claim 1, wherein the inspection provides employee education and security policies.

19. The virtual of claim 1 determined according to the ERP of the vendor, allowing each vendor to selectively use batch, real-time, and interactive data transmissions to communicate with the virtual hub.

20. The virtual hub of claim 1, wherein the message mail is selected from the group consisting of order/order confirmation replies, vendor OQA/IQC replies, return notices/classification/check inquiries, dead materials replies, and bulletin information reception.

21. The virtual hub of claim 1, wherein the plurality of security levels includes security of machines and computer hosts, security of external connections, security of network services, management of internal personnel security, and inspection.

22. The virtual hub of claim 1, wherein the satellite account virtual hub management system uses a bar code on line operation along with a radio frequency (RF) device to perform inventory management.

23. The virtual hub of claim 1, wherein the document handling system controls all documents through a bar code on line operation and transmits documents using the EDI.

24. The virtual hub of claim 1, wherein the data format conversion system uses a transmission protocol for one selected from the group consisting of the EDI, expandable markup language (XML), file transfer protocol (FTP) and browser.
